(19) United States
(12) Patent Application Publication
(10) Pub. No.: US 2019/0058773 A1
(43) Pub. Date: Feb. 21, 2019

(54) PUSH NOTIFICATION MANAGEMENT METHODS AND SYSTEMS FOR COMMUNICATION DATA

(71) Applicant: Bubboe Corporation, Taipei City (TW)

(72) Inventor: John C. Wang, Taipei City (TW)

(21) Appl. No.: 16/102,968

(22) Filed: Aug. 14, 2018

(30) Foreign Application Priority Data
Aug. 16, 2017 (TW) 106127693

(51) Int. Cl. H04L 29/08; H04L 12/58

(52) U.S. Cl. CPC H04L 67/26; H04L 51/10; H04L 67/30; H04L 51/24

(57) ABSTRACT

Push notification management methods and systems for communication data are provided. First, specific communication data is received from a first user device via a network. The specific communication data is analyzed to determine whether the specific communication data conforms to at least one preset data. When the specific communication data conforms to the preset data, the specific communication data is transmitted to a second user device via the network, and a push notification corresponding to the specific communication data is generated via the second user device.

### BACKGROUND OF THE INVENTION

### Field of the Invention

The disclosure relates generally to push notification management methods and systems for communication data, and, more particularly to methods and systems capable of automatically determining whether to perform a push notification after receiving communication data in a network communication environment.

### Description of the Related Art

Recently, portable devices, such as smart phones or notebooks, have become more and more technically advanced and multifunctional. For example, a portable device may have network connectivity capabilities. Users can use their portable devices to connect to networks anytime and anywhere. Due to the increased convenience and expanded functionalities of the devices, these devices have become necessities in life.

As a result of the popularity of applications for network communication in smartphones, communicating with friends online via smartphone applications has become a prevalent interaction method. Generally, users can input a text message or record a voice message, and send the text message or the voice message to a specific friend or members of a group. The specific friend or group members can read the text message or the voice message immediately or at their leisure.

In some cases, when there is a large number of members in a group, it is very difficult for the user to read a particular message in the group. For example, due to the large number of members in a group, the user may not be interested in the topics discussed or the messages sent by each member in the group. Conventionally, users must find messages sent by a particular friend or messages related to a specific topic among all messages in the group. The aforementioned procedures of finding a specific message in a large number of messages are cumbersome, time consuming, and become more serious when there is a large number of members in a group.

On the other hand, smartphones typically support a push notification function for the application APP. For example, when a member in a specific group of a network communication application sends a message, the smartphone can generate a corresponding push notification to notify the user. When there is a large number of members in the group, the user's smart phone must generate push notifications of the corresponding messages frequently. As the user may not be interested in these messages, the large number of push notifications will cause the user's inconvenience. In addition to causing inconvenience, the above-mentioned procedures of finding specific messages from several messages and generating a lot of push notifications may also waste the system resources of the smart phone significantly.

### BRIEF SUMMARY OF THE INVENTION

Push notification management methods and systems for communication data are provided, wherein whether to perform a push notification is automatically determined after receiving communication data in a network communication environment.

In an embodiment of a push notification management method for communication data, specific communication data is received from a first user device via a network. Then, the specific communication data is analyzed to determine whether the specific communication data conforms to at least one preset data. When the specific communication data conforms to the preset data, the specific communication data is transmitted to a second user device via the network, and a push notification corresponding to the specific communication data is generated via the second user device.

An embodiment of a push notification management system for communication data comprises a storage unit, a network connecting unit, and a processing unit. The storage unit comprises at least one preset data. The network connecting unit is configured to receive specific communication data from a first user device via a network. The processing unit is configured to analyze the specific communication data to determine whether the specific communication data conforms to the preset data. When the specific communication data conforms to the preset data, the processing unit transmits the specific communication data to a second user device via the network by the network connecting unit, and generates a push notification corresponding to the specific communication data via the second user device.

In some embodiments, when the specific communication data does not conform to the at least one preset data, the specific communication data is transmitted to the second user device via the network without generating the push notification corresponding to the specific communication data via the second user device. In some embodiments, the second user device further performs a network communication application service, and the specific communication data is transmitted to the network communication application service.

In some embodiments, determine whether the specific communication data conforms to the preset data can be performed by determining whether the specific communication data includes the preset data, wherein the preset data comprises text data, voice data, image data, or video data.

In some embodiments, a user interface is provided to receive the setting corresponding to the preset data from the second user device via the network.

In another embodiment of a push notification management method for communication data, a network communication application service is executed on the electronic device and specific communication data is received from a server via a network, wherein the server provides the network communication application service. Then, the specific communication data is analyzed to determine whether the specific communication data conforms to at least one preset data. When the specific communication data conforms to the preset data, a push notification corresponding to the specific communication data is generated via the electronic device.

Another embodiment of a push notification management system for communication data comprises a storage unit, a network connecting unit, and a processing unit. The storage unit comprises at least one preset data. The network connecting unit is configured to receive specific communication data from a server via a network, wherein the server provides a network communication application service. The processing unit is configured to analyze the specific communication data to execute the network communication application service and determine whether the specific communication data conforms to at least one preset data. When the specific communication data conforms to the preset data, the processing unit generates a push notification corresponding to the specific communication data via the electronic device.

In some embodiments, the setting corresponding to the preset data is received via a user interface.

Push notification management methods for communication data may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed descriptions with references to the accompanying drawings, wherein:

FIG. 1 is a schematic diagram illustrating an embodiment of a push notification management system for communication data of the invention;

FIG. 2 is a schematic diagram illustrating another embodiment of a push notification management system for communication data of the invention;

FIG. 3 is a schematic diagram illustrating another embodiment of a push notification management system for communication data of the invention;

FIG. 4 is a flowchart of an embodiment of a push notification management method for communication data of the invention;

FIG. 5 is a flowchart of another embodiment of a push notification management method for communication data of the invention; and

FIG. 6 is a flowchart of another embodiment of a push notification management method for communication data of the invention.

### DETAILED DESCRIPTION OF THE INVENTION

Push notification management methods and systems for communication data are provided.

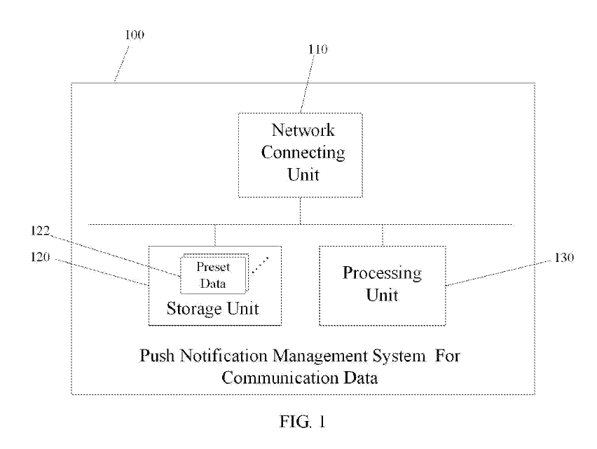

FIG. 1 is a schematic diagram illustrating an embodiment of a push notification management system for communication data of the invention. The push notification management system for communication data 100 can be used in an electronic device, such as a server, a computer, or a portable device, such as a mobile phone, a smart phone, a PDA (Personal Digital Assistant), a GPS (Global Positioning System), a notebook, or the like.

The push notification management system for communication data 100 can comprise a network connecting unit 110, a storage unit 120, and a processing unit 130. The network connecting unit 110 can connect to a network, such as a wired network, a telecommunication network, and/or a wireless network such as Bluetooth or Wi-Fi network. The electronic device can have network connectivity capabilities by using the network connecting unit 110. The storage unit 120 can comprise at least one preset data 122. It should be noted that, in some embodiments, the electronic device can provide a user interface for receiving the settings corresponding to the preset data 122. It should be noted that, in some embodiments, the preset data 122 can be text data, voice data, image data, and/or video data. The usage of the preset data 122 will be discussed later. The processing unit 130 can control related operations of hardware and software in the electronic device, and perform the push notification management methods for communication data of the present invention, which will be discussed later. It should be noted that, in some embodiments, the electronic device can provide a network communication application service. In other words, the electronic device can provide a data communication service between the user devices of the respective individual users.

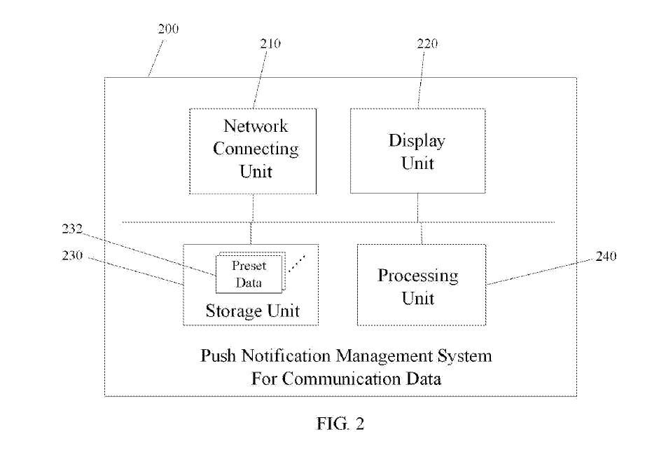

FIG. 2 is a schematic diagram illustrating another embodiment of a push notification management system for communication data of the invention. The push notification management system for communication data 200 can be used in an electronic device, such as a server, a computer, or a portable device, such as a mobile phone, a smart phone, a PDA (Personal Digital Assistant), a GPS (Global Positioning System), a notebook, or the like.

The push notification management system for communication data 200 can comprise a network connecting unit 210, a display unit 220, a storage unit 230, and a processing unit 240. The network connecting unit 210 can connect to a network, such as a wired network, a telecommunication network, and/or a wireless network such as Bluetooth or Wi-Fi network. The electronic device can have network connectivity capabilities by using the network connecting unit 210. The display unit 220 can display related information, such as images, interfaces, and/or data. It is understood that, in some embodiments, the display unit 220 may be a touch-sensitive screen. Users can directly input related data to the electronic device via the touch-sensitive screen. The storage unit 230 can comprise at least one preset data 232. It should be noted that, in some embodiments, the electronic device can provide a user interface for receiving the settings corresponding to the preset data 232. It should be noted that, in some embodiments, the preset data 232 can be text data, voice data, image data, and/or video data. The usage of the preset data 232 will be discussed later. The processing unit 240 can control related operations of hardware and software in the electronic device, and perform the push notification management methods for communication data of the present invention, which will be discussed later. It should be noted that, in some embodiments, the electronic device can execute a network communication application service/program. In other words, the electronic device can receive the communication data transmitted by the user device from respectively different users from a server providing the network communication application service. It should be noted that in some embodiments, the communication data can be an audio message, an image data, and/or a video data.

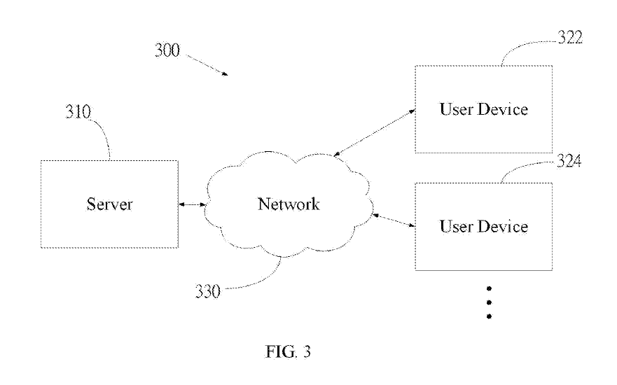

As aforementioned, in some embodiments, the user device of the respectively individual user can execute a network communication application service. Users can use their respective user devices to generate communication data for network communication. FIG. 3 is a schematic diagram illustrating another embodiment of a push notification management system for communication data of the invention. As shown in FIG. 3, the push notification management system for communication data 300 can comprise a server 310 and at least one user device (322, 324). The server 310 can have similar components as those in the architecture of FIG. 1. The user device may be any electronic device having network connectivity capabilities, such as a computer, or a portable device, such as a mobile phone, a smart phone, a PDA (Personal Digital Assistant), a GPS (Global Positioning System), or a notebook. The user device can have similar components as those in the architecture of FIG. 2. In some embodiments, the user device can connect to the server 310 via a network 330, such as a wired network, a telecommunication network, and/or a wireless network such as Bluetooth or Wi-Fi network. The server 310 provides a network communication application service, and the respective user device can install the application. In some embodiments, the application is a network communication application. Users can communicate with each other via the server 310 by using their user devices. The server 310 can provide a network communication application service, and the individual user device can install the application service. Users can use their respective user devices to communicate over the network through the server 310.

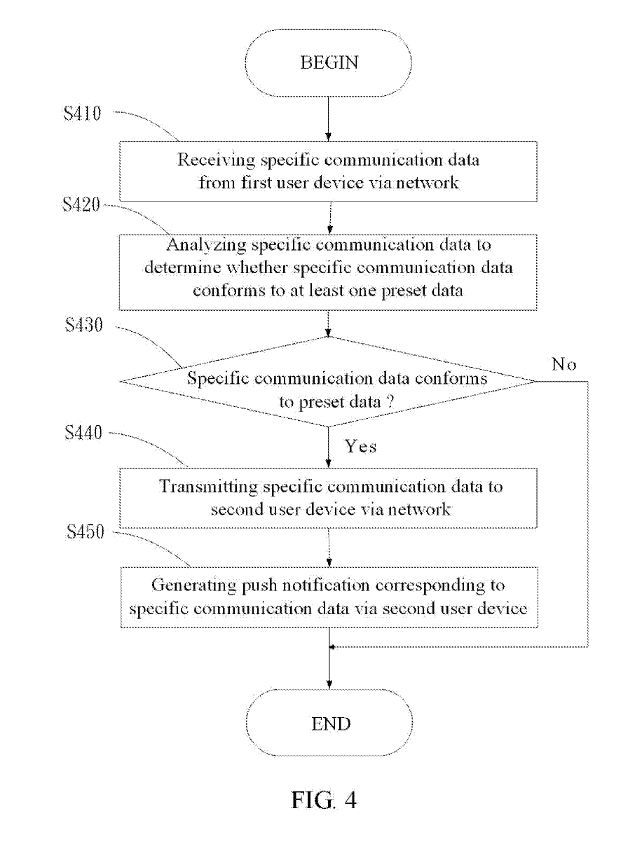

FIG. 4 is a flowchart of an embodiment of a push notification management method for communication data of the invention. The push notification management method for communication data can be used in an electronic device, such as the server 310 as shown in FIG. 3. It should be noted that, in this embodiment, the server 310 can provide a network communication application service.

First, in step S410, specific communication data is received by a first user device via a network. It should be noted that, in some embodiments, the specific communication data can be a voice message, an image data, and/or a video data. It should be understood that, the first user device can transmit specific communication data for a specific communication group. A plurality of users may be included in the specific communication group, and only a second communication devices in the specific communication group is taken as an example for illustration purpose in this embodiment. After receiving the specific communication data, in step S420, the specific communication data is analyzed to determine whether the specific communication data conforms to at least one preset data. It should be noted that, in some embodiments, a user interface may be provided to receive the setting corresponding to the preset data from the second user device via the network. It should be noted that, in some embodiments, the preset data may comprise a text data, a voice data, an image data, and/or a video data. In some embodiments, determining whether the specific communication data conforms to the preset data can be performed by determining whether the specific communication data includes the preset data. When the specific communication data does not conform to the preset data (No in step S430), the procedure is completed. When the specific communication data conforms to the preset data (Yes in step S430), in step S440, the specific communication data is transmitted to the second user device via the network, and in step S450, a push notification corresponding to the specific communication data is generated via the second user device. It is noted that, the second user device will generate a corresponding push notification only when the specific communication data conforms to the preset data.

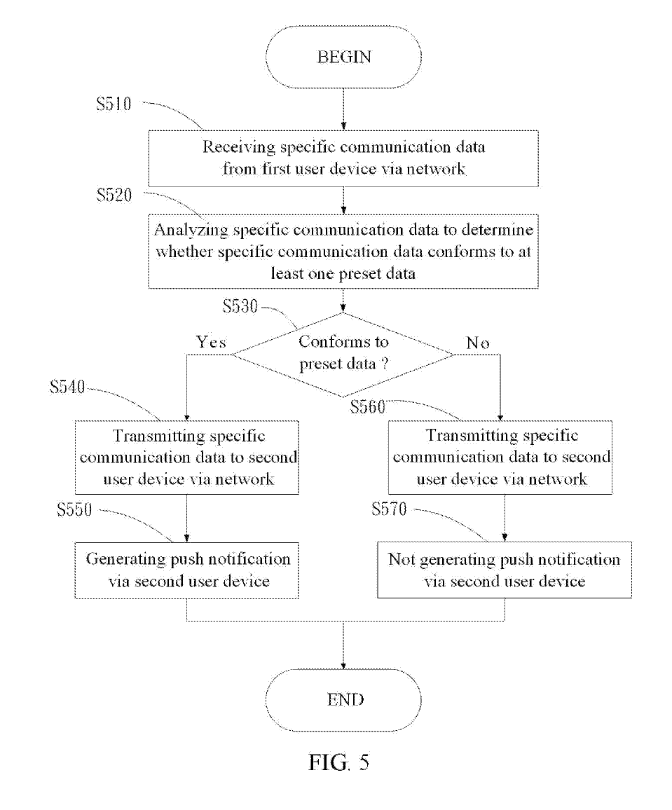

FIG. 5 is a flowchart of another embodiment of a push notification management method for communication data of the invention. The push notification management method for communication data can be used in an electronic device, such as the server 310 as shown in FIG. 3. It should be noted that, in this embodiment, the server 310 can provide a network communication application service.

First, in step S510, specific communication data is received from a first user device via a network. Similarly, in some embodiments, the specific communication data can be a voice message, an image data, and/or a video data. It should be understood that, the first user device can transmit specific communication data for a specific communication group. A plurality of users may be included in the specific communication group, and only a second communication devices in the specific communication group is taken as an example for illustration purpose in this embodiment. After receiving the specific communication data, in step S520, the specific communication data is analyzed to determine whether the specific communication data conforms to at least one preset data. Similarly, in some embodiments, a user interface may be provided to receive the setting corresponding to the preset data from the second user device via the network. It should be noted that, in some embodiments, the preset data may comprise a text data, a voice data, an image data, and/or a video data. In some embodiments, determining whether the specific communication data conforms to the preset data can be performed by determining whether the specific communication data includes the preset data. When the specific communication data conforms to the preset data (Yes in step S530), in step S540, the specific communication data is transmitted to the second user device via the network, and in step S550, a push notification corresponding to the specific communication data is generated via the second user device. When the specific communication data does not conform to the preset data (No in step S530), in step S560, the specific communication data is transmitted to the second user device via the network, and in step S570, a push notification corresponding to the specific communication data is not generated via the second user device. It is noted that, in the present invention, when the specific communication data does not conform to the preset data, only the specific communication data is displayed in the network communication application service/program of the user device, and the push notification will not be generated via the user device.

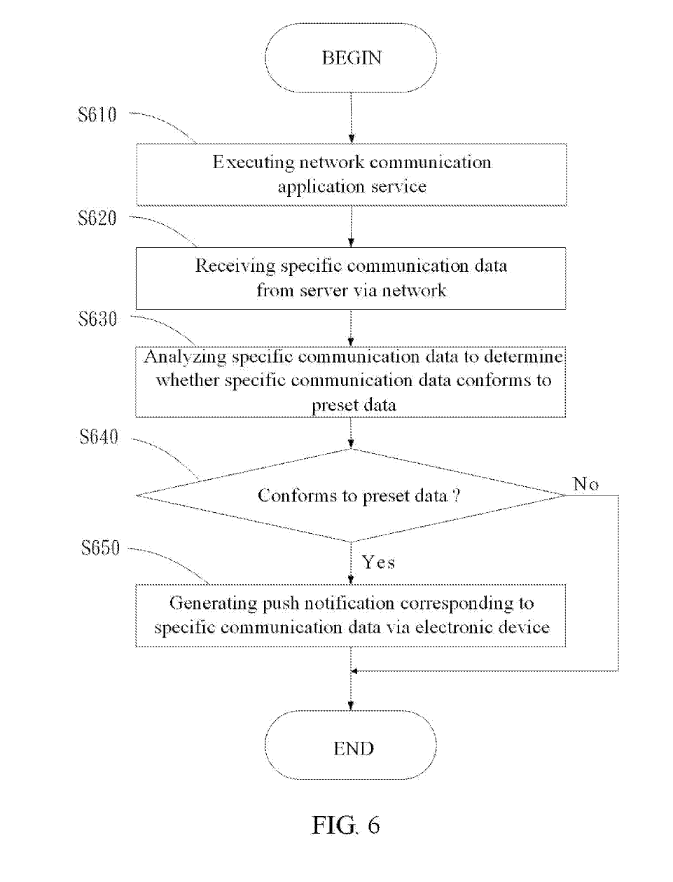

FIG. 6 is a flowchart of an embodiment of a push notification management method for communication data of the invention. The push notification management method for communication data can be used in an electronic device, such as the user device 322 as shown in FIG. 3.

First, in step S610, a network communication application service/program is executed in the electronic device. Then, in step S620, specific communication data is received from a server via a network. Similarly, in some embodiments, the specific communication data can be a voice message, an image data, and/or a video data. After receiving the specific communication data, in step S630, the specific communication data is analyzed to determine whether the specific communication data conforms to at least one preset data. It should be noted that, in some embodiments, a user interface may be provided to receive the setting corresponding to the preset data. In other words, the user of the electronic device can decide at its own discretion the push notifications corresponding to which specific communication data to receive. It should be noted that, in some embodiments, the preset data may comprise a text data, a voice data, an image data, and/or a video data. In some embodiments, determining whether the specific communication data conforms to the preset data can be performed by determining whether the specific communication data includes the preset data. When the specific communication data does not conform to the preset data (No in step S640), the procedure is completed. When the specific communication data conforms to the preset data (Yes in step S640), in step S650, a push notification corresponding to the specific communication data is generated via the electronic device. It is noted that, the electronic device will generate a corresponding push notification only when the specific communication data conforms to the preset data. When the specific communication data does not conform to the preset data, only the specific communication data is displayed in the network communication application service/program of the user device, and the push notification will not be generated via the electronic device.

Therefore, the push notification management methods and systems for communication data can automatically determine whether to perform the push notification after receiving communication data in a network communication environment, thus decreasing the difficulties of searching for specific messages from a huge number of messages and the disturbance caused by a huge amount of push notifications in the prior art, and further saving the system resources of smartphones wasted by the prior art procedures.

Push notification management methods for communication data may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A push notification management method for communication data for use in an electronic device, comprising:
receiving specific communication data from a first user device via a network;
analyzing the specific communication data to determine whether the specific communication data conforms to at least one preset data; and
when the specific communication data conforms to the at least one preset data, transmitting the specific communication data to a second user device via the network, and generating a push notification corresponding to the specific communication data via the second user device.

2. The method of claim 1, further comprising transmitting the specific communication data to the second user device via the network without generating the push notification corresponding to the specific communication data via the second user device when the specific communication data does not conform to the at least one preset data.

3. The method of claim 2, wherein the second user device further performs a network communication application service, and the specific communication data is transmitted to the network communication application service.

4. The method of claim 1, wherein determining whether the specific communication data conforms to the at least one preset data is performed by determining whether the specific communication data includes the at least one preset data, wherein the at least one preset data comprises text data, voice data, image data, or video data.

5. The method of claim 1, further comprising providing a user interface to receive the setting corresponding to the at least one preset data from the second user device via the network.

6. A push notification management method for communication data for use in an electronic device, comprising:
executing a network communication application service on the electronic device;
receiving specific communication data from a server via a network, wherein the server provides the network communication application service;
analyzing the specific communication data to determine whether the specific communication data conforms to at least one preset data; and
when the specific communication data conforms to the preset data, generating a push notification corresponding to the specific communication data via the electronic device.

7. The method of claim 6, further comprising receiving the setting corresponding to the preset data via a user interface.

8. A push notification management system for communication data for use in an electronic device, comprising:
a storage unit comprising at least one preset data;
a network connecting unit configured to receive specific communication data from a first user device via a network; and
a processing unit configured to analyze the specific communication data to determine whether the specific communication data conforms to at least one preset data, and when the specific communication data conforms to the preset data, transmit the specific communication data to a second user device via the network by the network connecting unit, and generate a push notification corresponding to the specific communication data via the second user device.

9. A push notification management system for communication data for use in an electronic device, comprising:
a storage unit comprising at least one preset data;
a network connecting unit configured to receive specific communication data from a server via a network; and
a processing unit configured to execute a network communication application service provided by the server, analyzes the specific communication data to determine whether the specific communication data conforms to at least one preset data, and when the specific communication data conforms to the preset data, generate a push notification corresponding to the specific communication data via the electronic device.

10. A machine-readable storage medium comprising a computer program, which, when executed, causes a device to perform a push notification management method for communication data, wherein the method comprises:
receiving specific communication data from a first user device via a network;
analyzing the specific communication data to determine whether the specific communication data conforms to at least one preset data; and
when the specific communication data conforms to the preset data, transmitting the specific communication data to a second user device via the network, and generating a push notification corresponding to the specific communication data via the second user device.

11. A machine-readable storage medium comprising a computer program, which, when executed, causes a device to perform a push notification management method for communication data, wherein the method comprises:
executing a network communication application service;
receiving specific communication data from a server via a network, wherein the server provides the network communication application service;
analyzing the specific communication data to determine whether the specific communication data conforms to at least one preset data; and
when the specific communication data conforms to the preset data, generating a push notification corresponding to the specific communication data via the electronic device.
